(19) United States
(12) Patent Application Publication
(10) Pub. No.: US 2026/0154027 A1
(43) Pub. Date: Jun. 4, 2026

(54) CONTENT SHARING APPARATUS, DEVICE, COMPUTER READABLE STORAGE MEDIUM AND PRODUCT

(71) Applicant: Beijing Zitiao Network Technology Co., Ltd., Beijing (CN)

(72) Inventors: Zijun ZHOU, Beijing (CN); Yaping Ll, Beijing (CN)

(21) Appl. No.: 19/127,020

(22) PCT Filed: Nov. 2, 2023
(86) PCT No.: PCT/CN2023/129368

§ 371 Date: May 2, 2025

(30) Foreign Application Priority Data
Nov. 3, 2022 (CN) 202211372039.7

(51) Int. Cl. G06F 3/14; G06F 3/0482; G06F 3/0484; H04L 51/046; H04L 51/10

(52) U.S. Cl. CPC G06F 3/1454; G06F 3/0482; G06F 3/0484; H04L 51/046; H04L 51/10

(57) ABSTRACT

Embodiments of the invention provide a content sharing method, apparatus, device, computer readable storage medium and product. The method includes: when a first user performs a real-time interaction operation with at least one second user, jumping to a media content play interface in response to a media content browsing request triggered by the first user; playing a first media content stream in the media content play interface, and displaying a content sharing control associated with the second user; and in response to a trigger operation on the content sharing control by the first user, sharing the target media content currently being played in the first media content stream to the at least one second user.

### CROSS-REFERENCE TO RELATED APPLICATIONS

This application is a U.S. National Stage Application of International Application No. PCT/CN 2023/129368, filed Nov. 2, 2023, which claims the benefit of Chinese Patent Application No. 202211372039.7, entitled “CONTENT SHARING APPARATUS, DEVICE, COMPUTER READABLE STORAGE MEDIUM AND PRODUCT” filed Nov. 3, 2022, the contents of which are incorporated herein by reference in their entireties

### FIELD

Embodiments of the invention relate to the technical field of human-computer interaction, in particular to a content sharing method, apparatus, device, computer readable storage medium and product.

### BACKGROUND

Currently, most application software can provide content browsing and real-time interaction functions.

### SUMMARY

Embodiments of the invention provide a content sharing method, apparatus, device, computer readable storage medium and product.

According to a first aspect, embodiments of the present disclosure provides a content sharing method, including:
when the first user performs a real-time interaction operation with at least one second user, jumping to the media content play interface in response to the media content browsing request triggered by the first user;
playing a first media content stream in the media content play interface, and displaying a content sharing control associated with the second user; and
in response to the trigger operation on the content sharing control by the first user, sharing target media content currently being played in the first media content stream to at least one second user.

According to a second aspect, embodiments of the present disclosure provides a content sharing apparatus, including:
a jumping module, configured to jump to a media content play interface in response to a media content browsing request triggered by a first user when the first user performs a real-time interaction operation with at least one second user;
a display module, configured to play a first media content stream in the media content play interface, and display a content sharing control associated with the second user;
a sharing module, configured to, in response to a trigger operation on the content sharing control by the first user, share the target media content currently being played in the first media content stream to at least one second user.

According to a third aspect, embodiments of the present disclosure provides an electronic device, including: at least one processor and a memory;
the memory storing computer executable instructions,
the computer-executable instructions stored in the memory, when executed by the memory, causing the at least one processor to execute the content sharing method according to the first aspect and various possible designs of the first aspect.

According to a fourth aspect, embodiments of the present disclosure provides a computer-readable storage medium, where the computer-readable storage medium stores computer-executable instructions, and when the processor executes the computer-executable instruction, the content sharing method according to the first aspect and the possible designs of the first aspect is implemented.

According to a fifth aspect, embodiments of the present disclosure provides a computer program product, including a computer executable instruction, and when the processor executes the computer executable instruction, the content sharing method according to the first aspect and various possible designs of the first aspect is implemented.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is a schematic flowchart of a content sharing method according to embodiments of the present disclosure;

FIG. 2 is a schematic diagram of interface interaction according to embodiments of the present disclosure;

FIG. 3 is a schematic flowchart of a content sharing method according to another embodiment of the present disclosure;

FIG. 4A is a schematic diagram of a display interface according to embodiments of the present disclosure;

FIG. 4B is a schematic diagram of another display interface according to embodiments of the present disclosure;

FIG. 5 is a schematic diagram of another interface interaction according to embodiments of the present disclosure;

FIG. 6 is a schematic diagram of another display interface according to embodiments of the present disclosure;

FIG. 7 is a schematic diagram of another display interface according to embodiments of the present disclosure;

FIG. 8 is a schematic diagram of another display interface according to embodiments of the present disclosure;

FIG. 9 is a schematic flowchart of a content sharing method according to still another embodiment of the present disclosure;

FIG. 10 is a schematic structural diagram of a content sharing apparatus according to embodiments of the present disclosure;

FIG. 11 is a schematic structural diagram of an electronic device according to embodiments of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. All other embodiments obtained by those skilled in the art based on the embodiments of the present disclosure without creative efforts shall fall within the scope of the present disclosure.

The present disclosure provides a content sharing method, apparatus, device, computer-readable storage medium, and product.

It should be noted that the content sharing method, apparatus, device, computer-readable storage medium, and product provided by the present disclosure may be applied to a scenario of content sharing in various real-time interaction processes.

When a user performs a real-time interaction operation by using the application software, for example, when a voice or video call is performed, if a certain piece of media content provided in the application software is desired to be forwarded, operations of multiple steps need to be performed. Thus the user may not interact with other users conveniently and quickly.

In an existing content sharing operation in a real-time interaction process, when a first user needs to share display content in a content browsing interface to a second user being interacted with in real time, generally a content sharing request triggered by a first user may be obtained, a user list is displayed according to the content sharing request, and the user list includes all second users that have an association relationship with the first user. The content to be shared is shared to the second user selected by the user according to the selection operation on the user list by the first user. Alternatively, it is necessary to jump to a conversation interface of the second user who is interacted with in real time to share the display content. Therefore, the operation is complicated, and the content sharing efficiency is low.

In order to simplify the operation process of content sharing, a content sharing control associated with a second user interacting with the first user in real time may be set in a media content play interface. Therefore, the target media content currently being played may be shared to the second user in response to the trigger operation on the content sharing control by the first user.

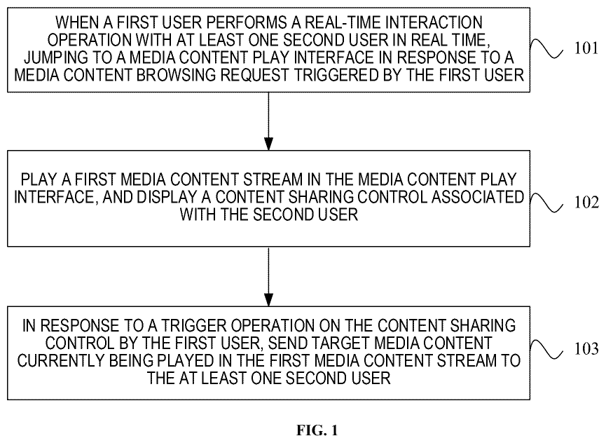

FIG. 1 is a schematic flowchart of a content sharing method according to embodiments of the present disclosure. As illustrated in FIG. 1, the method includes the following steps.

Step 101: when a first user performs a real-time interaction operation with at least one second user, a media content play interface is jumped to in response to a media content browsing request triggered by the first user.

The executing body of the embodiment is a content sharing apparatus, and the content sharing apparatus may be coupled in a terminal device, so that the content sharing operation can be performed in response to the control instruction triggered by the user on the terminal device. Optionally, the content sharing apparatus may alternatively be coupled in a server, and the server may be communicatively connected to the terminal device, to obtain a control instruction triggered by the user on the terminal device, and control the terminal device to implement the content sharing operation.

In the embodiment, the first user may perform a real-time interaction operation with the second user. The second user may be a user having a predetermined association relationship with the first user. For example, the second user may be a friend of interest with the first user. The real-time interaction operation may include interaction operations such as a real-time voice call operation, a real-time video call operation, a real-time media content sharing operation, and a real-time conference.

When the first user and the second user interact in real time, the first user may exit a real-time interaction interface and trigger a media content browsing request while the interaction operation is maintained. In response to the media content browsing request, the media content play interface may be jumped to.

Step 102: a first media content stream in the media content play interface is played, and a content sharing control associated with the second user is displayed.

In the embodiment, the first media content stream may be played in the media content play interface. Therefore, the first user can browse the media content in the first media content stream within the media content play interface.

Further, in order to simplify the operation process of content sharing, the content sharing control associated with the second user may be displayed in the media content play interface. The content sharing control may be displayed in a predetermined display area, for example, the content sharing control may be displayed at the upper right corner of the media content play interface. Optionally, the content sharing control may also be displayed in a display area that does not cause occlusion to the first media content stream being played. Optionally, the user may also adjust display parameters such as a display position and a display size of the content sharing control according to actual requirements, which is not limited in the present disclosure.

Step 103: the target media content currently being played in the first media content stream is shared to at least one second user in response to a trigger operation on the content sharing control by the first user.

In the embodiment, in the process of browsing the media content in the first media content stream, the first user may share the target media content currently being played to the second user according to the actual requirement. To implement the sharing operation on the target media content, the first user may trigger an operation on the content sharing control. The trigger operation includes, but is not limited to, a single-click operation, a double-click operation, a long-press operation, a drag operation, and the like, which is not limited in the present disclosure.

Accordingly, the content sharing apparatus may share the target media content currently being played in the first media content stream to the at least one second user in response to the trigger operation on the content sharing control by the first user.

Optionally, if the number of the second user currently interacting with the first user is one, the target media content may be directly shared to the second user. If there are a plurality of second users currently interacting with the first user in real time, the target media content may be shared to each second user, or the target media content may be shared to some second users. The first user may adjust according to actual requirements, which is not limited in the present disclosure.

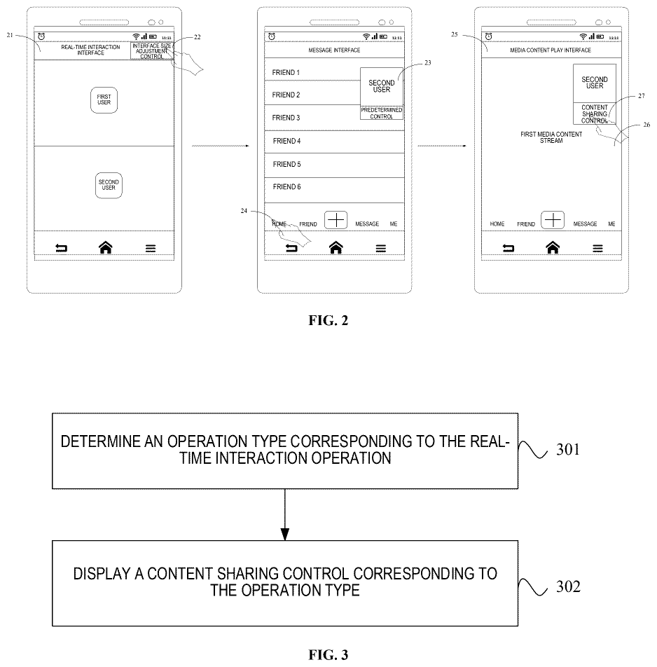

FIG. 2 is a schematic diagram of an interface interaction according to embodiments of the present disclosure. As illustrated in FIG. 2, a real-time interaction interface 21 may be displayed during a real-time interaction between the first user and the second user. The first user may zoom out the real-time interaction interface 21 to a real-time interaction window 23 by triggering a predetermined interface size adjustment control 22. In response to the user's trigger operation on a media content play interface control 24, a media content play interface 25 may be jumped to. Within the media content play interface 25, a first media content stream 26 may be played and a content sharing control 27 associated with second user(s) may be displayed. Therefore, the first user may trigger the content sharing control 27 to perform the sharing operation on the target media content currently being played. It can be understood that FIG. 2 is merely an example, and in other embodiments, the trigger operation on the real-time interaction interface may cause direct jumping to the media content play interface.

Optionally, if the current display interface is an interface other than the media content play interface, the real-time interaction window may be displayed, and a further predetermined function control may be displayed. For example, an interaction control for performing a predetermined interaction operation with the second user may be displayed.

According to the content sharing method provided in the embodiment, the content sharing control associated with the second user that is currently performing the real-time interaction operation is displayed in the media content play interface, so that the target media content currently being played can be quickly shared to the second user in response to the trigger operation on the content sharing control by the first user. The content sharing operation process is simplified, the content sharing efficiency is improved, and the user experience can be improved.

FIG. 3 is a schematic flowchart of a content sharing method according to another embodiment of the present disclosure. As illustrated in FIG. 3, Step 102 comprises the following:
Step 301: determine an operation type corresponding to the real-time interaction operation; and
Step 302: display a content sharing control corresponding to the operation type.

In the embodiment, the first user and the second user may perform different types of real-time interaction operations. The real-time interaction operation may specifically include a first operation type and a second operation type. The first operation type is used to represent that the first user and the second user perform a real-time call operation. The second operation type is used to represent that the first user and the second user perform a real-time media content sharing operation.

For example, the first operation type may specifically include a voice call operation, a video call operation, and the like between the first user and the second user. The second operation type may specifically include an interaction operation of simultaneously viewing sharing media content stream by the first user and the second user, simultaneously viewing different media content streams by the first user and the second user, and maintaining an interaction operation of the call.

The real-time interaction operations of different operation types may correspond to different content sharing operations. For example, when the first user performs the voice call operation with the second user, the target media content may be shared to a chat interface of the second user, or the target media content may be shared to the second user, to cause the media content is displayed in the interaction window displayed in the media content play interface of the second user. When the first user and the second user perform the real-time media content sharing operation, the target media content may be shared into a chat interface of the second user, or the target media content may be inserted into a sharing content stream currently being viewed.

Therefore, to implement different content sharing operations, an operation type corresponding to the real-time interaction operation may be determined, and a content sharing control matching the operation type may be displayed.

According to the content sharing method provided in the embodiment, different content sharing controls are configured for different operation types. Therefore, different types of content sharing operations can be performed based on the content sharing control matched with the real-time interaction operation when the user performs different real-time interaction operations. The diversity of the content sharing operation is improved.

Further, on the basis of any one of the foregoing embodiments, the operation type includes a first operation type representing that the first user and the second user perform a real-time call operation. Step 202 includes:
displaying a first interaction window and at least one sharing control associated with the second user in the media content play interface, where the first interaction window is configured to perform the real-time call operation.

Alternatively, Step 202 includes:
displaying a first interaction window and a function control associated with the second user in the media content play interface; and
displaying a predetermined sharing control list in response to a trigger operation on the function control by the user, where the sharing control list includes at least one sharing control associated with the second user.

In the embodiment, the real-time interaction operation may specifically include a first operation type. The first operation type is used to represent that the first user and the second user perform a real-time call operation.

When the first user and the second user perform a real-time call operation, the target media content may be shared into a chat interface of the second user, or the target media content may be shared to the second user, to cause the media content to be displayed in the interaction window displayed in the media content play interface of the second user.

Therefore, a first interaction window and at least one sharing control associated with the second user may be displayed in the media content play interface, where the first interaction window is used to perform a real-time call operation. For example, when the first user performs a voice call with the second user, the first interaction window may display the identification information of the second user, or may display the identification information of the currently speaking user. When the first user and the second user perform the video call, the real-time image information of the second user may be displayed in the first interaction window.

The sharing control may specifically include a first sharing control and a second sharing control. The first sharing control is configured to share the target media content into the chat interface of the second user when triggered. The second sharing control is configured to, when triggered, share the target media content to the second user, to cause the media content to be displayed in the interaction window displayed in the media content play interface of the second user.

The media content play interface may only display the first sharing control or the second sharing control, or may display the first sharing control and the second sharing control at the same time, which is not limited in the present disclosure. In some embodiments, when the second sharing control is triggered, in addition to causing the media content to be displayed in the media content play interface of the second user, the target media content may be sent to the chat interface of the at least one second user.

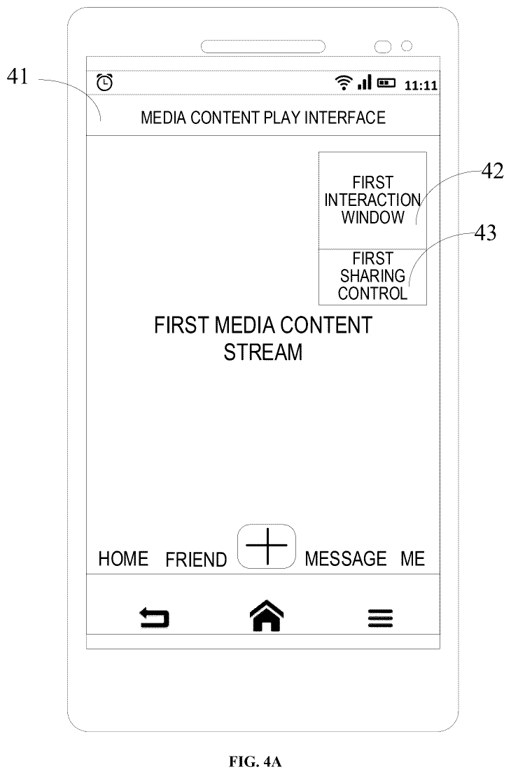

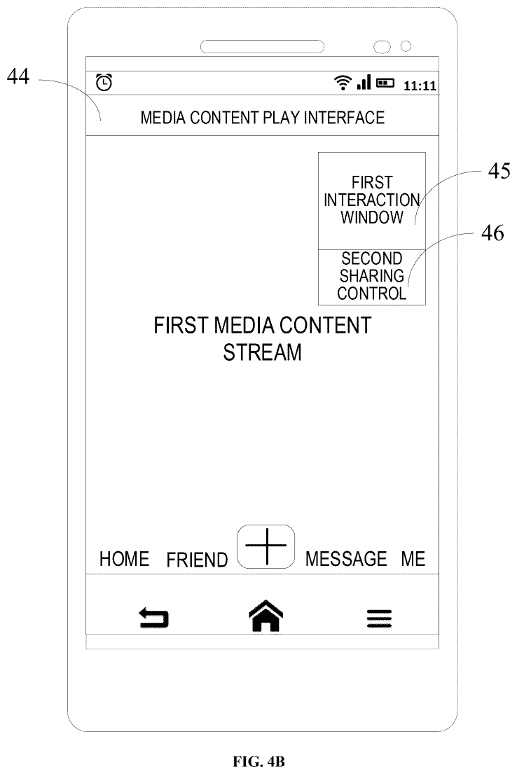

FIG. 4A is a schematic diagram of a display interface according to embodiments of the present disclosure. A first interaction window 42 may display identification information of the second user or image information corresponding to the second user. A first sharing control 43 may be specifically a sharing control. FIG. 4B is a schematic diagram of another display interface according to embodiments of the present disclosure. As shown in FIG. 4B, a first interaction window 45 and a second sharing control 46 associated with a second user may be displayed in a media content play interface 44. The second sharing control 46 may be specifically a viewing-together control.

Optionally, a first interaction window and a function control associated with the second user may be displayed in the media content play interface. A predetermined sharing control list is displayed in response to a trigger operation on the function control by the user, where the sharing control list includes at least one sharing control associated with the second user. The sharing control may specifically include a first sharing control and a second sharing control.

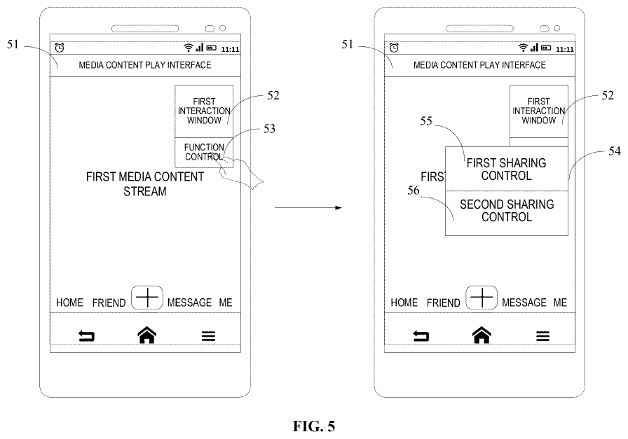

FIG. 5 is a schematic diagram of another interface interaction according to embodiments of the present disclosure. In response to a trigger operation on a function control 53 by the first user, a sharing control list 54 may be displayed, where the sharing control list 54 includes a first sharing control 55 and a second sharing control 56 associated with the second user.

According to the content sharing method provided in the embodiment, when the first user and the second user perform the real-time interaction operation of the first operation type, at least one sharing control associated with the second user is displayed in the media content play interface, so that different sharing operations on the target media content are achieved based on the at least one sharing control. Therefore, the sharing channel of content sharing can be enriched in addition to simplification of the content sharing process.

Further, on the basis of any one of the above embodiments, the at least one sharing control includes a first sharing control, and step 103 includes:
sending the target media content to a chat interface corresponding to at least one second user in response to a trigger operation on the first sharing control by the first user.

In the embodiment, the at least one sharing control may include a first sharing control. The first user may trigger an operation on the first sharing control according to an actual requirement. In response to the trigger operation, the target media content may be sent to a chat interface corresponding to the at least one second user. Therefore, the second user can view the target media content in the chat interface.

Optionally, after the target media content is sent to the chat interface corresponding to the at least one second user, prompt information may be sent to each second user. Therefore, the second user can quickly jump to viewing the target media content in the chat interface by triggering the prompt information, thereby simplifying the viewing process of the target media content.

According to the content sharing method provided by the embodiment, the target media content is sent to the chat interface corresponding to the at least one second user based on the trigger operation on the first sharing control by the first user, so that the sharing operation on the target media content can be quickly achieved through the first sharing control. The process of sharing the target media content is simplified, and the content sharing efficiency is improved.

Further, on the basis of any one of the above embodiments, the at least one sharing control includes a second sharing control, and step 103 includes:
in response to a trigger operation on the second sharing control by the first user, sending the target media content to at least one second user, to cause a second interaction window of the second user to display the target media content, or
in response to the trigger operation on the second sharing control by the first user, sending the target media content to at least one second user, to cause the target media content to be sent to a chat interface of the at least one second user while the target media content is displayed in the second interaction window of the second user.

In the embodiment, the at least one sharing control includes a second sharing control. In response to the trigger operation on the second sharing control by the first user, the target media content may be sent to the at least one second user, so that the second interaction window of the second user displays the target media content. Therefore, the first user can browse the target media content simultaneously with the second user.

Optionally, in response to the trigger operation on the second sharing control by the first user, the target media content may be sent to the at least one second user, so that the second interaction window displays the target media content, and the target media content is sent to the chat interface of the at least one second user. In this way, the second user can also view the target media content in the chat interface.

According to the content sharing method provided by the embodiment, the target media content is sent to the at least one second user in response to the trigger operation on the second sharing control by the first user, so that the second user can browse the target media content in the second interaction window, and the sharing and viewing operation process of the target media content is effectively simplified.

Optionally, on the basis of any one of the foregoing embodiments, the operation type includes a second operation type representing that the first user and the second user perform a real-time media content sharing operation. Step 102 includes:
displaying, in the media content play interface, a third interaction window and a content sharing control associated with the second user, where the third interaction window is configured to perform the real-time media content sharing operation.

In the embodiment, the operation type may further include a second operation type, and the second operation type is used to represent that the first user and the second user perform the real-time media content sharing operation. When the first user and the second user perform the real-time media content sharing operation, the first user may further browse the first media content stream. Therefore, a third interaction window associated with the second user may be displayed in the media content play interface, where the third interaction window is used to perform the real-time media content sharing operation.

In order to facilitate the sharing operation on the target media content, the content sharing control may be further displayed in the media content play interface.

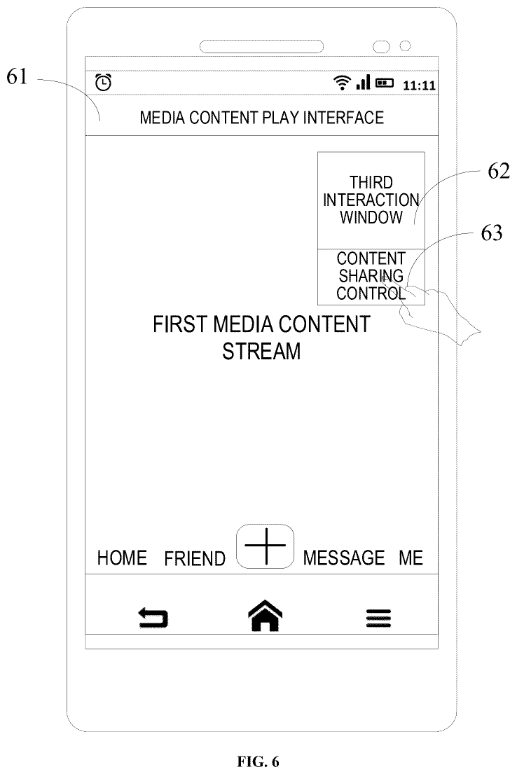

FIG. 6 is a schematic diagram of another display interface according to embodiments of the present disclosure. As illustrated in FIG. 6, a media content play interface 61 displays a third interaction window 62 and a content sharing control 63 associated with the second user. The third interaction window 62 may display a real-time media content stream.

According to the content sharing method provided by the embodiment, when the first user and the second user perform the real-time interaction operation of the second operation type, the third interaction window and the content sharing control associated with the second user are displayed in the media content play interface, so that the first user can quickly share the target media content to the second user through the content sharing control, the sharing process of the target media content is simplified, and the user experience is improved.

Further, on the basis of any one of the above embodiments, displaying the third interaction window and the content sharing control associated with the second user in the media content play interface includes:
displaying, in the third interaction window associated with the second user, a sharing media content stream that the first user views simultaneously with the second user, and displaying the content sharing control.

In the embodiment, when the first user and the second user perform the real-time media content sharing operation, the first user and the second user may view the same sharing media content stream. When the first user performs the browsing operation of the first media content stream, the sharing media content stream simultaneously viewed by the first user and the second user may be displayed in the third interaction window, to implement the real-time media content sharing operation.

In addition, a first sharing control may be displayed. The first user sends the target media content to the chat interface of the second user through the content sharing control, to implement the sharing operation on the target media content.

Further, on the basis of any one of the above embodiments, the content sharing control includes a third sharing control, and the step 103 includes:
in response to a trigger operation on the third sharing control by the first user, sending the target media content to at least one second user to cause a predetermined content stream played in a second interaction window of the second user includes the target media content, and/or sending the target media content to a chat interface of the at least one second user.

In the embodiment, the first user may trigger the third sharing control according to the actual requirement. In response to the trigger operation, the target media content may be sent to the at least one second user, so that the predetermined content stream played in the second interaction window of the second user includes the target media content. The target media content may be added to a first position in the predetermined content stream, or may be added to a predetermined position in the predetermined content stream. This is not limited in the present disclosure. For example, a sharing media content stream 73 includes the predetermined content stream, and the predetermined content stream is a set of media content that has not been played yet in the sharing media content stream 73.

Optionally, in response to the trigger operation on the third sharing control by the first user, the target media content may be sent to the chat interface of the at least one second user.

It should be noted that the foregoing two implementations may be implemented separately or in combination. This is not limited in the present disclosure. When implemented in combination, the target media content may be sent to the at least one second user, so that the predetermined content stream played in the second interaction window of the second user includes the target media content, and the target media content is sent to the chat interface of the at least one second user. In this way, the second user can also view the target media content in the chat interface.

FIG. 7 is a schematic diagram of another display interface according to embodiments of the present disclosure. As illustrated in FIG. 7, a media content play interface 71 may display a third interaction window 72 associated with the second user. The third interaction window 72 may display a sharing media content stream 73 that is simultaneously viewed by the first user and the second user and a third sharing control 74.

According to the content sharing method provided by the embodiment, the sharing media content stream viewed by the first user and the second user at the same time is displayed in the third interaction window associated with the second user, and the third sharing control is displayed. Thus when the first user and the second user simultaneously view the sharing media content stream, the content in the first media content stream currently viewed by the first user is shared into the sharing media content stream, so that the second user can browse the target media content stream in the third interaction window, thereby achieving rapid sharing of the target media content.

Further, on the basis of any one of the above embodiments, displaying the third interaction window and the content sharing control associated with the second user in the media content play interface includes:
displaying a second media content stream being viewed by the second user in a third interaction window associated with the second user, and displaying the content sharing control.

In the embodiment, when the first user and the second user perform the real-time media content sharing operation, the first user and the second user may view different media content streams. For example, the first user and the second user may simultaneously watch media content, the first user views a first media content stream, and the second user views a second media content stream. In the third interaction window associated with the second user, the second media content stream that the second user is viewing may be displayed. In order to quickly achieve the sharing operation of the target media content, the content sharing control may also be displayed.

Further, on the basis of any one of the above embodiments, the content sharing control includes a fourth sharing control, and step 103 includes:
in response to a trigger operation on the fourth sharing control by the first user, sharing one or more pieces of media content in the first media content stream to at least one second user, to cause one or more pieces of media content in the first media content stream to be played in the second interaction window of the second user.

In the embodiment, when the first user and the second user separately view different media content streams, in response to a trigger operation on the fourth sharing control by the first user, one or more pieces of media content in the first media content stream may be shared to the at least one second user. Therefore, when the one or more pieces of media content in the first media content stream is obtained, the one or more pieces of media content in the first media content stream may be played within the second interaction window. Further, the second user can view the content in the first media content stream browsed by the first user.

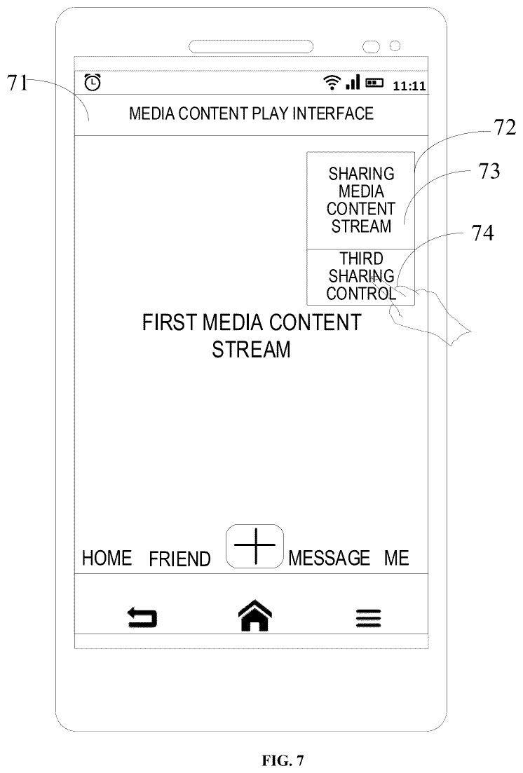

FIG. 8 is a schematic diagram of another display interface according to embodiments of the present disclosure. As illustrated in FIG. 8, a media content play interface 81 may display a third interaction window 82 associated with the second user. A second media content stream 83 that the second user is viewing and a fourth sharing control 84 may be displayed in the third interaction window 82.

According to the content sharing method provided in the embodiment, the second media content stream that the second user is viewing is displayed in the third interaction window associated with the second user, and the fourth sharing control is displayed, so that the first user can view the media content that the second user is currently browsing within the media content play interface. In addition, the target media content may be quickly shared to the second user through the fourth sharing control. On the basis of simplifying the sharing process of the target media content, the interaction mode between the first user and the second user is enriched, and the user experience is improved.

Further, on the basis of any one of the above embodiments, step 103 includes:
in response to a trigger operation on the content sharing control by the first user, determining whether the first user and the at least one second user belong to a target group in which the real-time interaction operation is being performed; and
if yes, sharing the target media content to the target group or the at least one second user in the target group.

In the embodiment, when the first user performs a real-time interaction operation with the at least one second user, the first user and the at least one second user may belong to a target group that is performing a real-time interaction operation, for example, the first user may perform a real-time call operation with at least part of users in a group chat.

Therefore, in response to the trigger operation on the content sharing control by the first user, it may be determined whether the first user and the at least one second user belong to the target group in which the real-time interaction operation is being performed. If yes, the target media content may be shared to the target group or the at least one second user in the target group.

Optionally, in response to the trigger operation on the content sharing control by the first user, when it is determined that the first user and the at least one second user belong to the target group in which the real-time interaction operation is being performed, a user list corresponding to the target group may be displayed, and in response to a selection operation on the user list by the first user, the target media content is shared to the second user selected by the first user.

Optionally, the target media content may be shared to the target group or the chat interface of each second user, to enable each second user to realize a viewing operation on the target media content in the chat interface. Alternatively, the target media content may be sent to each second user, and the target media content may be played in the media content play interface of each second user. Alternatively, the target media content may be sent to each second user, and the target media content may be played in a second interaction window in the media content play interface of each second user. Alternatively, the target media content may also be sent to each second user, and the target media content may be added to the predetermined position in the second media content stream currently browsed by the second user. This is not limited in the present disclosure.

According to the content sharing method provided by the embodiment, in response to the trigger operation on the content sharing control by the first user, when the first user and the at least one second user belong to the target group in which the real-time interaction operation is being performed, the target media content is shared to the at least one second user in the target group or the target group, so that the target media content can be quickly shared to the plurality of second users, and the content sharing efficiency is improved.

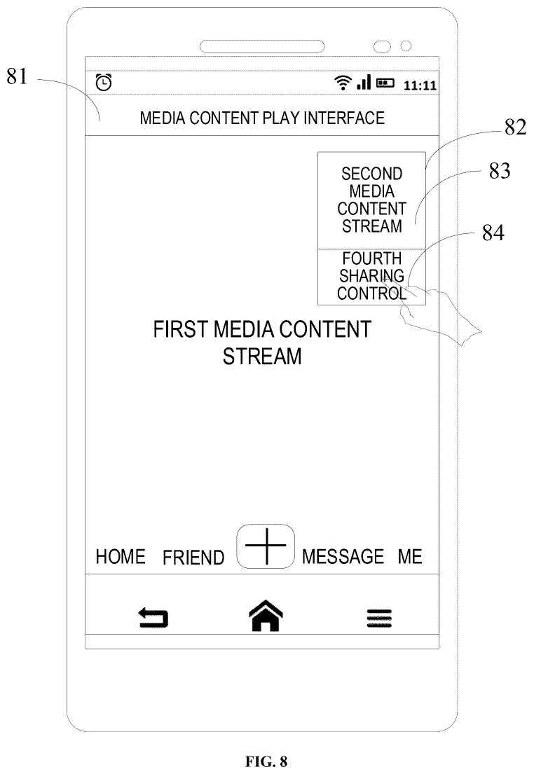

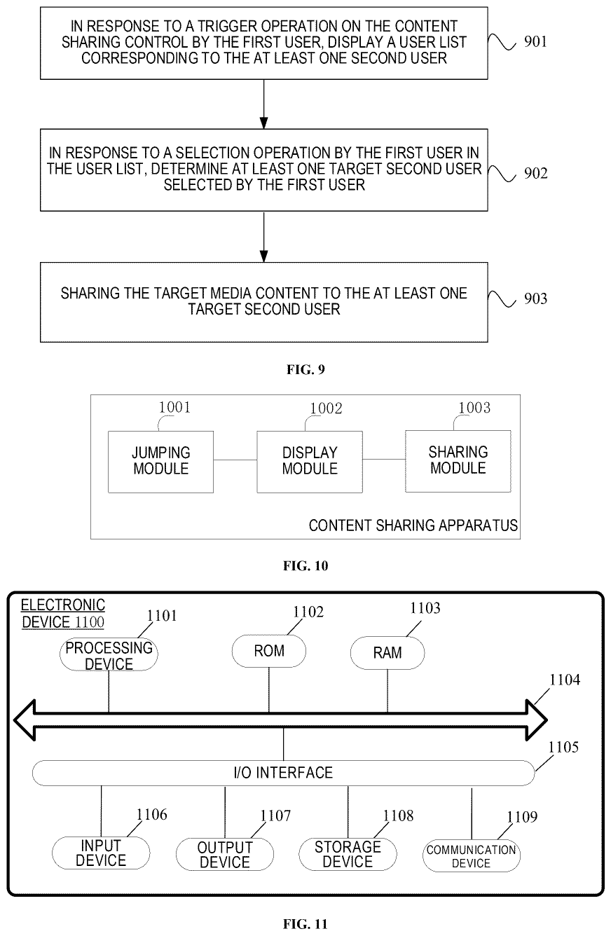

FIG. 9 is a schematic flowchart of a content sharing method according to another embodiment of the present disclosure. As illustrated in FIG. 9, Step 103 includes:
Step 901: displaying a user list corresponding to the at least one second user in response to a trigger operation on the content sharing control by the first user;
Step 902: determining, in response to a selection operation on the user list by the first user, at least one target second user selected by the first user; and
In step 903, sharing the target media content to the at least one target second user.

In the embodiment, when there are a plurality of second users performing the real-time interaction operation with the first user, the first user may select the target second user to perform the sharing operation of the target media content according to the actual requirement.

Optionally, in response to the trigger operation on the content sharing control by the first user, the user list corresponding to the at least one second user is displayed. The user list includes all second users currently interacting with the first user in real time.

At least one target second user selected by the first user is determined in response to a selection operation on the user list by the first user. The target media content is shared to at least one target second user.

According to the content sharing method provided by the embodiment, the user list corresponding to the at least one second user is displayed in response to the trigger operation on the content sharing control by the first user, the target media content is shared to the at least one target second user selected by the first user based on the selection operation on the user list by the first user, so that the target media content can be quickly shared to the multiple target second users, thus the content sharing operation is more consistent with the personalized requirement of the first user, and the user experience is improved.

FIG. 10 is a schematic structural diagram of a content sharing apparatus according to embodiments of the present disclosure. The jumping module 1001 is configured to jump to a media content play interface in response to a media content browsing request triggered by a first user when the first user performs a real-time interaction operation with at least one second user. The display module 1002 is configured to play a first media content stream in the media content play interface, and display a content sharing control associated with the second user. A sharing module 1003 is configured to, in response to a trigger operation on the content sharing control by the first user, share the target media content currently being played in the first media content stream to the at least one second user.

Further, on the basis of any one of the above embodiments, the display module is configured to determine an operation type corresponding to the real-time interaction operation; and displaying a content sharing control corresponding to the operation type.

Further, on the basis of any one of the foregoing embodiments, the operation type includes a first operation type representing that the first user and the second user perform a real-time call operation. The display module is configured to display a first interaction window and at least one sharing control associated with the second user in the media content play interface, where the first interaction window is used to perform the real-time call operation. Alternatively, the display module is configured to display a first interaction window and a function control associated with the second user in the media content play interface; and display a predetermined sharing control list in response to a trigger operation on the function control by a user, where the sharing control list includes at least one sharing control associated with the second user.

Further, on the basis of any one of the foregoing embodiments, the at least one sharing control includes a first sharing control, and the sharing module is configured to: in response to a trigger operation on the first sharing control by the first user, send the target media content to a chat interface corresponding to the at least one second user.

Further, on the basis of any one of the foregoing embodiments, the at least one sharing control includes a second sharing control, and the sharing module is configured to: in response to a trigger operation on the second sharing control by the first user, send the target media content to at least one second user, to cause a second interaction window of the second user to display the target media content, or in response to a trigger operation on the second sharing control by the first user, send the target media content to at least one second user, to cause the second interaction window of the second user to display the target media content and to send the target media content to a chat interface of the at least one second user.

Further, on the basis of any one of the foregoing embodiments, the operation type includes a second operation type representing that the first user and the second user perform a real-time media content sharing operation. The display module is configured to: display, in the media content play interface, a third interaction window associated with the second user and a first sharing control, where the third interaction window is used to perform the real-time media content sharing operation.

Further, on the basis of any one of the foregoing embodiments, the display module is configured to: display, in a third interaction window associated with the second user, a sharing media content stream that is simultaneously viewed by the first user and the second user, and display the first sharing control, or display a second media content stream being viewed by the second user in a third interaction window associated with the second user, and display the first sharing control.

Further, on the basis of any one of the foregoing embodiments, the sharing module is configured to: in response to a trigger operation on the first sharing control by the first user, send the target media content to the at least one second user, to cause a predetermined content stream played in a second interaction window of the second user to include the target media content, and/or send the target media content to a chat interface of the at least one second user. Alternatively, in response to a trigger operation on the first sharing control by the first user, one or more pieces of media content in the first media content stream are shared to the at least one second user, to cause the one or more pieces of media content in the first media content stream to be played in the second interaction window of the second user.

Further, on the basis of any one of the above embodiments, the sharing module is configured to: in response to a trigger operation of the first user on the content sharing control, determine whether the first user and the at least one second user belong to a target group in which the real-time interaction operation is being performed. If yes, sharing the target media content to at least one second user in the target group or the target group.

Further, on the basis of any one of the above embodiments, the sharing module is configured to: in response to a trigger operation on the content sharing control by the first user, display a user list corresponding to the at least one second user; determine at least one target second user selected by the first user in response to a selection operation on the user list by the first user; and share the target media content to the at least one target second user.

The device provided in the embodiment may be configured to perform the technical solutions in the foregoing method embodiments, and implementation principles and technical effects thereof are similar, and details are not described herein again in the embodiment.

Yet another embodiment of the present disclosure further provides an electronic device, including: at least one processor and a memory.

The memory stores computer-executable instructions.

The at least one processor executes the computer-executable instructions stored in the memory, so that the at least one processor executes the content sharing method according to any one of the foregoing embodiments.

FIG. 11 is a schematic structural diagram of an electronic device according to embodiments of the present disclosure. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 11 is merely an example, and should not impose any limitation on the functions and scope of use of the embodiments of the present disclosure.

As shown in FIG. 11, the electronic device 1100 may include a processing device (for example, a central processing unit, a graphics processor, etc.) 1101, which may perform various appropriate actions and processing according to a program stored in a read only memory (ROM) 1102 or a program loaded into a random access memory (RAM) 1103 from a storage device 1108. In the RAM 1103, various programs and data required by the operation of the electronic device 1100 are also stored. The processing device 1101, the ROM 1102, and the RAM 1103 are connected to each other through a bus 1104. Input/output (I/O) interface 1105 is also connected to bus 1104.

Generally, the following devices may be connected to the I/O interface 1105: an input device 1106 including, for example, a touch screen, a touch pad, a keyboard, a mouse, a camera, a microphone, an accelerometer, a gyroscope, etc. ; an output device 1107 including, for example, a liquid crystal display (LCD), a speaker, a vibrator, etc. ; a storage device 1108 including, for example, a magnetic tape, a hard disk, etc. ; and a communication device 1109. The communication device 1109 may allow the electronic device 1100 to communicate wirelessly or wired with other devices to exchange data. While FIG. 11 shows an electronic device 1100 having various devices, it should be understood that it is not required to implement or have all illustrated devices. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 1109, or installed from the storage device 1108, or from the ROM 1102. When the computer program is executed by the processing apparatus 1101, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

Another embodiment of the present disclosure further provides a computer-readable storage medium, where the computer-readable storage medium stores computer-executable instructions, and when the processor executes the content sharing method according to any one of the foregoing embodiments.

Another embodiment of the present disclosure further provides a computer program product, including a computer executable instruction, and when the processor executes the computer executable instruction, the content sharing method according to any one of the foregoing embodiments is implemented.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to a first aspect, a content sharing method is provided according to one or more embodiments of the present disclosure, including:
when a first user performs a real-time interaction operation with at least one second user, jumping to a media content play interface in response to a media content browsing request triggered by the first user;
playing a first media content stream in the media content play interface, and displaying a content sharing control associated with the second user; and
in response to the trigger operation on the content sharing control by the first user, sharing the target media content currently being played in the first media content stream to the at least one second user.

According to one or more embodiments of the present disclosure, displaying the content sharing control associated with the second user includes:
determining an operation type corresponding to the real-time interaction operation; and
displaying a content sharing control corresponding to the operation type.

According to one or more embodiments of the present disclosure, the operation type includes a first operation type representing that the first user and the second user perform a real-time call operation; and displaying the content sharing control corresponding to the operation type includes:
displaying a first interaction window and at least one sharing control associated with the second user in the media content play interface, where the first interaction window is used to perform the real-time call operation;

Alternatively, displaying the content sharing control corresponding to the operation type includes:
displaying a first interaction window and a function control associated with the second user in the media content play interface; and
displaying a predetermined sharing control list in response to a trigger operation on the function control by the user, where the sharing control list includes at least one sharing control associated with the second user.

According to one or more embodiments of the present disclosure, the at least one sharing control includes a first sharing control, and sharing, in response to the trigger operation on the content sharing control by the first user, target media content currently played in the first media content stream to the at least one second user includes:
sending the target media content to a chat interface corresponding to at least one second user in response to a trigger operation on the first sharing control by the first user.

According to one or more embodiments of the present disclosure, the at least one sharing control includes a second sharing control configured to:
in response to a trigger operation on the second sharing control by the first user, send the target media content to at least one second user, to cause a second interaction window of the second user to display the target media content, or
in response to the trigger operation on the second sharing control by the first user, send the target media content to at least one second user, to cause the second interaction window of the second user to display the target media content while the target media content is sent to a chat interface of the at least one second user.

According to one or more embodiments of the present disclosure, the operation type includes a second operation type representing that the first user and the second user perform a real-time media content sharing operation; and
displaying the content sharing control corresponding to the operation type includes:
displaying, in the media content play interface, a third interaction window and a content sharing control associated with the second user, where the third interaction window is used to perform the real-time media content sharing operation.

According to one or more embodiments of the present disclosure, displaying the third interaction window and a content sharing control associated with the second user in the media content play interface includes:
displaying, in a third interaction window associated with the second user, a sharing media content stream simultaneously viewed by the first user and the second user, and displaying the content sharing control;
or,
displaying a second media content stream being viewed by the second user in a third interaction window associated with the second user, and displaying the content sharing control.

According to one or more embodiments of the present disclosure,
the content sharing control includes a third sharing control or a fourth sharing control; and
sharing the target media content currently played in the first media content stream to at least one second user in response to the trigger operation on the content sharing control by the first user includes:
sending the target media content to at least one second user in response to a trigger operation on the third sharing control by the first user, to cause a predetermined content stream played in a second interaction window of the second user to include the target media content, and/or send the target media content to a chat interface of the at least one second user;
or,
in response to a trigger operation on the fourth sharing control by the first user, sharing one or more pieces of media content in the first media content stream to at least one second user, to cause the one or more pieces of media content in the first media content stream to be played in the second interaction window of the second user.

According to one or more embodiments of the present disclosure,
sharing the target media content currently being played in the first media content stream to at least one second user in response to the trigger operation on the content sharing control by the first user includes:
determining, in response to a trigger operation on the content sharing control by the first user, whether the first user and the at least one second user belong to a target group in which the real-time interaction operation is being performed; and
if yes, sharing the target media content to the at least one second user in the target group or the target group.

According to one or more embodiments of the present disclosure, sharing, in response to the trigger operation on the content sharing control by the first user, target media content currently being played in the first media content stream to the at least one second user includes:
displaying a user list corresponding to the at least one second user in response to a trigger operation on the content sharing control by the first user;
determining at least one target second user selected by the first user in response to a selection operation on the user list by the first user; and
sharing the target media content to the at least one target second user.

According to a second aspect, a content sharing apparatus is provided according to one or more embodiments of the present disclosure, including:
a jumping module, configured to jump to a media content play interface in response to a media content browsing request triggered by a first user when the first user performs a real-time interaction operation with at least one second user;
a display module, configured to play a first media content stream in the media content play interface, and display a content sharing control associated with the second user; and
a sharing module, configured to, in response to a trigger operation on the content sharing control by the first user, share the target media content currently being played in the first media content stream to the at least one second user.

According to one or more embodiments of the present disclosure, the display module is configured to:
determine an operation type corresponding to the real-time interaction operation; and
display a content sharing control corresponding to the operation type.

According to one or more embodiments of the present disclosure, the operation type includes a first operation type representing a real-time call operation between the first user and the second user; and the display module is configured to:
display a first interaction window and at least one sharing control associated with the second user in the media content play interface, where the first interaction window is used to perform the real-time call operation;

Alternatively, the display module is configured to:
display a first interaction window and a function control associated with the second user in the media content play interface; and
display a predetermined sharing control list in response to a trigger operation on the function control by a user, where the sharing control list includes at least one sharing control associated with the second user.

According to one or more embodiments of the present disclosure, the at least one sharing control includes a first sharing control, and the sharing module is configured to:
send the target media content to a chat interface corresponding to at least one second user in response to a trigger operation on the first sharing control by the first user.

According to one or more embodiments of the present disclosure, the at least one sharing control includes a second sharing control, and the sharing module is configured to:
in response to a trigger operation on the second sharing control by the first user, send the target media content to at least one second user, to cause a second interaction window of the second user to display the target media content, or
in response to the trigger operation on the second sharing control by the first user, send the target media content to at least one second user, to cause the second interaction window of the second user to display the target media content while the target media content is sent to a chat interface of the at least one second user.

According to one or more embodiments of the present disclosure, the operation type includes a second operation type representing that the first user and the second user perform a real-time media content sharing operation; and
the display module is configured to:
display, in the media content play interface, a third interaction window and a content sharing control associated with the second user, where the third interaction window is used to perform the real-time media content sharing operation.

According to one or more embodiments of the present disclosure, the display module is configured to:
display, in a third interaction window associated with the second user, a sharing media content stream simultaneously viewed by the first user and the second user, and display the content sharing control;
or,
displaying a second media content stream being viewed by the second user in a third interaction window associated with the second user, and display the content sharing control.

According to one or more embodiments of the present disclosure, the content sharing control includes a third sharing control or a fourth sharing control; and the sharing module is configured to:
send the target media content to at least one second user in response to a trigger operation on the third sharing control by the first user, to cause a predetermined content stream played in a second interaction window of the second user to include the target media content, and/or send the target media content to a chat interface of the at least one second user;
or,
in response to a trigger operation on the fourth sharing control by the first user, share one or more pieces of media content in the first media content stream to at least one second user, to cause the one or more pieces of media content in the first media content stream to be played in the second interaction window of the second user.

According to one or more embodiments of the present disclosure, the sharing module is configured to:
determine, in response to a trigger operation on the content sharing control by the first user, whether the first user and the at least one second user belong to a target group in which the real-time interaction operation is being performed; and
if yes, share the target media content to at least one second user in the target group or the target group.

According to one or more embodiments of the present disclosure, the sharing module is configured to:
display a user list corresponding to the at least one second user in response to a trigger operation on the content sharing control by the first user;
determine at least one target second user selected by the first user in response to a selection operation on the user list by the first user; and
share the target media content to the at least one target second user.

According to a third aspect, an electronic device is provided according to one or more embodiments of the present disclosure, including: at least one processor and a memory;
the memory storing computer executable instructions; and
the at least one processor executes the computer-executable instructions stored in the memory, so that the at least one processor executes the content sharing method according to the first aspect and various possible designs of the first aspect.

According to a fourth aspect, a computer-readable storage medium is provided according to one or more embodiments of the present disclosure, where the computer-readable storage medium stores computer-executable instructions, and when the processor executes the computer-executable instruction, the content sharing method according to the first aspect and the possible designs of the first aspect is implemented.

According to a fifth aspect, a computer program product is provided according to one or more embodiments of the present disclosure, including a computer program, where when the computer program is executed by a processor, the content sharing method according to the first aspect and various possible designs of the first aspect is implemented.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1-14. (canceled)

15. A method of content sharing, comprising:
during a real-time interaction between a first user and at least one second user, in response to a media content browsing request triggered by the first user, switching to a media content play interface;
playing a first media content stream in the media content play interface, and displaying a content sharing control associated with the second user; and
in response to a trigger on the content sharing control by the first user, sharing a media content currently being played in the first media content stream to the at least one second user.

16. The method of claim 15, wherein displaying the content sharing control associated with the second user comprises:
determining a type corresponding to the real-time interaction; and
displaying the content sharing control corresponding to the type.

17. The method of claim 16, wherein the type comprises a first type representing that the first user performs a real-time call with the second user; and
displaying the content sharing control corresponding to the type comprises:
displaying a first interaction window and at least one type of sharing control associated with the second user in the media content play interface, the first interaction window configured to perform the real-time call;
or displaying the content sharing control corresponding to the type comprises:
displaying a first interaction window and a function control associated with the second user in the media content play interface; and
in response to a trigger on the function control by a user, displaying a predetermined sharing control list comprising at least one type of sharing control associated with the second user.

18. The method of claim 17, wherein the at least one type of sharing control comprises a first sharing control, and in response to the trigger on the content sharing control by the first user, sharing the media content currently being played in the first media content stream to the at least one second user comprises:
in response to a trigger on the first sharing control by the first user, sending the media content to a chat interface corresponding to the at least one second user.

19. The method of claim 17, wherein the at least one type of sharing control comprises a second sharing control, and in response to the trigger on the content sharing control by the first user, sharing the media content currently being played in the first media content stream to the at least one second user comprises:
in response to a trigger on the second sharing control by the first user, sending the media content to the at least one second user to cause a second interaction window of the second user to display the media content, or
in response to a trigger on the second sharing control by the first user, sending the media content to the at least one second user to cause a second interaction window of the second user to display the media content while sending the media content to the chat interface of the at least one second user.

20. The method of claim 16, wherein the type comprises a second type representing that the first user performs real-time media content sharing with the second user, and
displaying the content sharing control corresponding to the type comprises:
displaying, in the media content play interface, a third interaction window and a content sharing control associated with the second user, wherein the third interaction window is configured to perform the real-time media content sharing.

21. The method of claim 20, wherein displaying, in the media content play interface, the third interaction window and the content sharing control associated with the second user comprises:
displaying a sharing media content stream simultaneously viewed by the first user and the second user in a third interaction window associated with the second user, and displaying the content sharing control, or
displaying a second media content stream being viewed by the second user in a third interaction window associated with the second user, and displaying the content sharing control.

22. The method of claim 20, wherein the content sharing control comprises a third sharing control or a fourth sharing control, and
in response to the trigger on the content sharing control by the first user, sharing the media content currently being played in the first media content stream to the at least one second user comprises:
in response to a trigger on the third sharing control by the first user, sending the media content to the at least one second user to cause a predetermined content stream played in a second interaction window of the second user to comprise the media content, and/or sending the media content to a chat interface of the at least one second user, or
in response to a trigger on the fourth sharing control by the first user, sharing one or more pieces of media content in the first media content stream to the at least one second user, to cause the one or more pieces of media content in the first media content stream to be played in the second interaction window of the second user.

23. The method of claim 15, wherein in response to the trigger on the content sharing control by the first user, sharing the media content currently being played in the first media content stream to the at least one second user comprises:
in response to a trigger on the content sharing control by the first user, determining whether the first user and the at least one second user belong to a target group in which the real-time interaction is being performed;
in accordance with a determination that the first user and the at least one second user belong to the target group, sharing the media content to the target group or the at least one second user in the target group.

24. The method of claim 15, wherein in response to the trigger of the first user on the content sharing control, sharing the media content currently being played in the first media content stream to the at least one second user comprises:
in response to a trigger on the content sharing control by the first user, displaying a user list corresponding to the at least one second user;
in response to a selection by the first user in the user list, determining at least one target second user selected by the first user; and
sharing the media content to the at least one target second user.

25. An electronic device, comprising: at least one processor and a memory;
the memory storing computer executable instructions; and
the computer-executable instructions, when executed by the at least one processor, causing the at least one processor to perform acts comprising:
during a real-time interaction between a first user and at least one second user, in response to a media content browsing request triggered by the first user, switching to a media content play interface;
playing a first media content stream in the media content play interface, and displaying a content sharing control associated with the second user; and
in response to a trigger on the content sharing control by the first user, sharing a media content currently being played in the first media content stream to the at least one second user.

26. The electronic device of claim 25, wherein displaying the content sharing control associated with the second user comprises:
determining a type corresponding to the real-time interaction; and
displaying the content sharing control corresponding to the type.

27. The electronic device of claim 26, wherein the type comprises a first type representing that the first user performs a real-time call with the second user; and
displaying the content sharing control corresponding to the type comprises:
displaying a first interaction window and at least one type of sharing control associated with the second user in the media content play interface, the first interaction window configured to perform the real-time call;
or displaying the content sharing control corresponding to the type comprises:
displaying a first interaction window and a function control associated with the second user in the media content play interface; and
in response to a trigger on the function control by a user, displaying a predetermined sharing control list comprising at least one type of sharing control associated with the second user.

28. The electronic device of claim 27, wherein the at least one type of sharing control comprises a first sharing control, and in response to the trigger on the content sharing control by the first user, sharing the media content currently being played in the first media content stream to the at least one second user comprises:
in response to a trigger on the first sharing control by the first user, sending the media content to a chat interface corresponding to the at least one second user.

29. The electronic device of claim 27, wherein the at least one type of sharing control comprises a second sharing control, and in response to the trigger on the content sharing control by the first user, sharing the media content currently being played in the first media content stream to the at least one second user comprises:
in response to a trigger on the second sharing control by the first user, sending the media content to the at least one second user to cause a second interaction window of the second user to display the media content, or
in response to a trigger on the second sharing control by the first user, sending the media content to the at least one second user to cause a second interaction window of the second user to display the media content while sending the media content to the chat interface of the at least one second user.

30. The electronic device of claim 26, wherein the type comprises a second type representing that the first user performs real-time media content sharing with the second user, and
displaying the content sharing control corresponding to the type comprises:
displaying, in the media content play interface, a third interaction window and a content sharing control associated with the second user, wherein the third interaction window is configured to perform the real-time media content sharing.

31. The electronic device of claim 30, wherein displaying, in the media content play interface, the third interaction window and the content sharing control associated with the second user comprises:
displaying a sharing media content stream simultaneously viewed by the first user and the second user in a third interaction window associated with the second user, and displaying the content sharing control, or
displaying a second media content stream being viewed by the second user in a third interaction window associated with the second user, and displaying the content sharing control.

32. The electronic device of claim 30, wherein the content sharing control comprises a third sharing control or a fourth sharing control, and
in response to the trigger on the content sharing control by the first user, sharing the media content currently being played in the first media content stream to the at least one second user comprises:
in response to a trigger on the third sharing control by the first user, sending the media content to the at least one second user to cause a predetermined content stream played in a second interaction window of the second user to comprise the media content, and/or sending the media content to a chat interface of the at least one second user, or
in response to a trigger on the fourth sharing control by the first user, sharing one or more pieces of media content in the first media content stream to the at least one second user, to cause the one or more pieces of media content in the first media content stream to be played in the second interaction window of the second user.

33. The electronic device of claim 25, wherein in response to the trigger on the content sharing control by the first user, sharing the media content currently being played in the first media content stream to the at least one second user comprises:
in response to a trigger on the content sharing control by the first user, determining whether the first user and the at least one second user belong to a target group in which the real-time interaction is being performed;
in accordance with a determination that the first user and the at least one second user belong to the target group, sharing the media content to the target group or the at least one second user in the target group.

34. A non-transitory computer-readable storage medium storing computer-executable instructions, the computer-executable instructions, when executed by the processor, implementing the method of content sharing comprising:
during a real-time interaction between a first user and at least one second user, in response to a media content browsing request triggered by the first user, switching to a media content play interface;
playing a first media content stream in the media content play interface, and displaying a content sharing control associated with the second user; and
in response to a trigger on the content sharing control by the first user, sharing a media content currently being played in the first media content stream to the at least one second user.
